(19) United States
(12) Patent Application Publication
(10) Pub. No.: US 2014/0227077 A1
(43) Pub. Date: Aug. 14, 2014

(54) Magnowind Turbine

(71) Applicants: Bjørn Inge Johansen, Orkanger (NO); Zafar Hameed, Trondheim (NO); Per Gunnar Auran, Trondheim (NO)

(72) Inventors: Bjørn Inge Johansen, Orkanger (NO); Zafar Hameed, Trondheim (NO); Per Gunnar Auran, Trondheim (NO)

(21) Appl. No.: 13/766,815

(22) Filed: Feb. 14, 2013

(51) Int. Cl. F03D 3/00

(52) U.S. Cl. CPC F03D 3/007
USPC 415/10

(57) ABSTRACT

A vertical wind turbine includes an upstanding 3 feet support structure, the top cover contains magnets carefully placed in a specific geometric pattern that generates a rotational force. The cover also has openings to allow for vertical air flow through the structure. Another set of permanent magnets are placed below the rotor shaft for magnetic levitation, resulting in near friction-free rotation. It has a total of 6 airfoils, 3 primary horizontal blades and 3 secondary vertical aerodynamic airfoils in 45 degree angle, thus increasing the total efficiency of wind capture. In summary MagnoWind is a small wind turbine operating on low wind speeds. It utilizes strong permanent magnets strategically aligned to maximize spinning momentum. The magnets counterbalance the weight of the spinning body while minimizing the needed wind force to generate power.

### CROSS-REFERENCES TO RELATED APPLICATIONS

Below is the application number and filing date for the provisional patent of MagnoWind turbine filed on Feb. 23, 2013. The non-provisional utility patent will be filed with 3 inventors (names above). The provisional patent was filed with 1 inventor, Bjøorn Johansen.

application Ser. No.: 61/634,085

Filed: Feb. 23, 2012

U.S. Confirmation 2772

U.S. C1: 509-03(r-8)

Small entity status 37 cfr. 1.27

### STATEMENT REGARDING FEDERALLY SPONSORED RESEARCH OR DEVELOPMENT

Not applicable

### MICROFICHE APPENDIX

Not applicable

### FIELD OF THE INVENTION

The present invention relates to the field of renewables as a source of energy solutions. In specific, MagnoWind is a small 120 cm×80 cm), low-speed (starting approx 0.5 to 1 m/s), vertical axis wind turbine that maximizes the energy production aiming at 2.4 to 3 kwh of supplementary energy. It reduces energy costs, generates self distributed green energy, and engages people actively in preserving the environment.

### BACKGROUND

One of the main reasons for the high increase in global pollution is attributed to our dependency on traditional sources of energy like fossil fuels and hydro power. In order to reduce fossil fuel dependency, and the human footprint, research is focused on increasing the share of renewable energy sources in the global market. There are several sources of renewable sources available for energy production, and among them, wind energy has captured a high level of interest. The last three decades, wind energy demand has increased globally. Currently, the installations of wind turbines are on their peak and focus is shifting from onshore to offshore locations. Vertical-axis small wind turbines has its advantages such as low and cost effective maintenance, avoids landscape and noise pollution and it creates self distributed energy. The biggest challenge with small wind turbines is to improve its efficiency output and durability vs. its physical size and positioning.

### SUMMARY

MagnoWind turbine presents a solution to some of the challenges encountered in the market today and provides a unique advantage in the vertical-axis small wind turbine field. In specific, the present invention presents a vertical-axis small wind turbine that combines magnets that counterbalance the weight of the spinning body and maximize the momentum force while minimizing the wind force to get it rotating and maintaining the spinning momentum. Consequently, improving the start up wind speed to the lowest possible.

### BRIEF DESCRIPTION OF THE FIGURES AND PARTS

TABLE 1 Summarizes the Individual Parts of the MagnoWind Turbine

FIG. 1 front view showing wind turbines and several parts:
Bottom plate (FIG. 1 part 1): is connected to the poles for windmill stabilization, it contains stators for power collection and magnet ring to uphold the rotating unit in MagnoWind.
Supporter poles (FIG. 1 part 2): These poles hold the unit together and are intended to be used for attachment to support construction.
Magnet ring top (FIG. 1 part 3): This magnet ring counter works with the magnet in the bottom plate in order to lift the rotating unit.
Top Key (Hidden in FIG. 1, refer to Table 1, part 4): This is the top magnet key that stabilizes the rotating unit in the center of main shaft.
Rotor bottom (FIG. 1 part 5): This holds the magnet ring top (3) creating stable lift and also contains (a potential) rotor generator for power output.
Shaft MagnoWind (FIG. 1 part 7): Contains magnet ring to counterbalance top key (4) maintaining stable rotation.
Blade MagnoWind (FIG. 1 part 9): This blade contains 3 vertical airfoils and 3 horizontal blades for maximum output of wind.
Rod for nut (FIG. 1 part 10): It holds the construction together in bottom center and is adjustable with a nut.
Nuts (FIG. 1 part 11): There are 4 nuts in the construction for adjustment of magnetic balancing field in the center of turbine, 2 nuts are for adjusting and 2 nuts function as lock nuts.
Top cover (FIG. 1 part 13): It has aerodynamic holes to allow excess air out of the windmill and is designed to push any form of moisture buildup out of the windmill.
Top cover for magnets (FIG. 1 part 14): This ring is attached to the top cover and contains angle-shaped magnets in order to aid the spinning of the construction.

FIG. 2 complete view of the unit laying down position showing parts hidden under the top cover
Rotor top (FIG. 2 part 5): This contains stabilizer magnet on top of the construction, and can also contain (a potential) rotor for power generation.
Magnetic ring (FIG. 2 part 12): The magnetics facilitates the rotation of the blades.
Stator top (FIG. 2 part 8): This contains stators for power output in top of the construction.

FIG. 3 is an isolated view, shoring the details of e holes on the top cover, and the sustainable supported frame of the unit.

FIG. 4 is an isolated view of the horizontal and vertical airfoil blades (45 degree angle), it shows the design of one solid piece in order to last longer and to avoid wear and tear.

FIG. 5 is an isolated top view from the rotor showing the position of the magnetic.

FIG. 6 is an isolated view from the top magnetic ring.

FIG. 7 is showing a specific part the magnetic ring.

FIG. 7 A is showing a specific pattern of the magnetic ring.

FIG. 8 it is a close up view of the placement of the magnetic ring to lifts the unit making it friction free.

### DETAILED DESCRIPTION

FIG. 1, together with the parts list in Table 1 shows an embodiment of MagnoWind, a micro vertical-axis wind turbine (VAWT) that utilizes a combination of magnetic levitation and tangential forces to increase efficiency above that given by wind forces alone.

FIG. 2 shows the micro wind turbine from below, allowing the view of the optional stator and rotor plates, part 8 and 5, respectively. These are optional in that alternatively an off-the-shelf three-phase generator can be attached to the main shaft (FIG. 2, part 7) and placed in the top cover (FIG. 2, part 8).

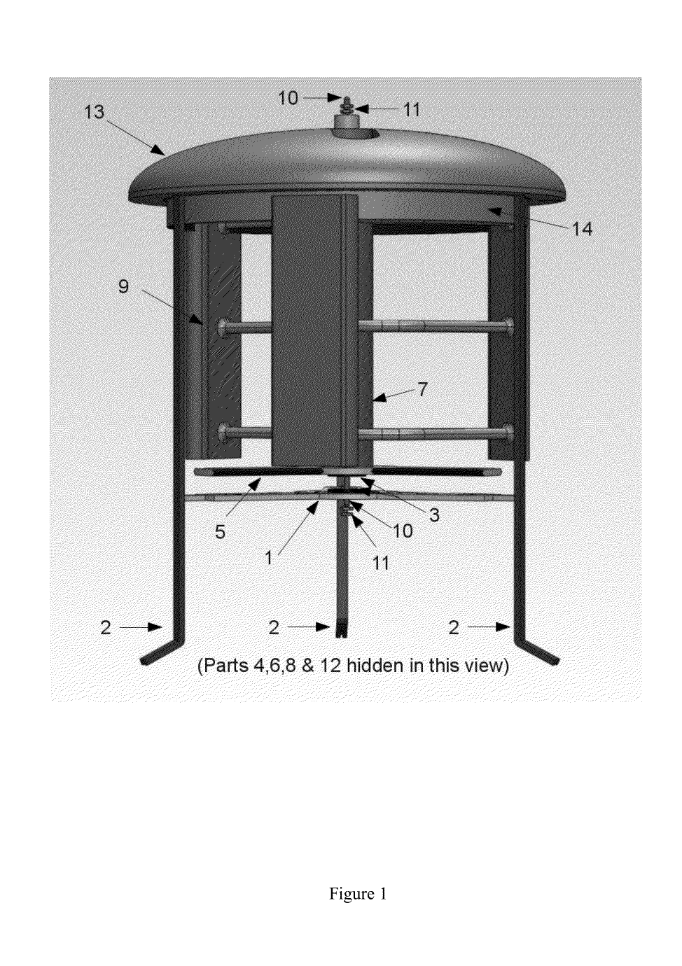

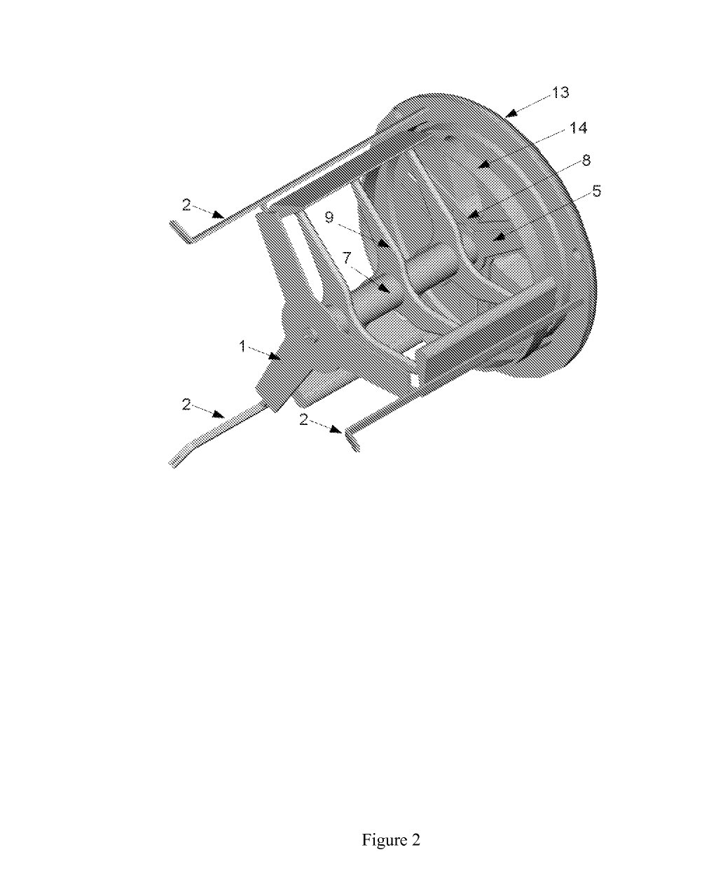

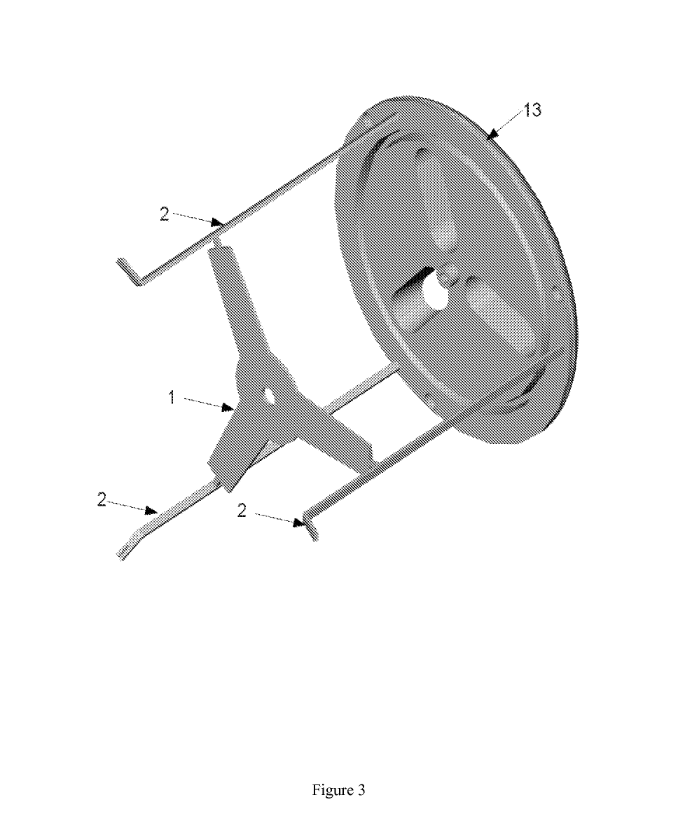

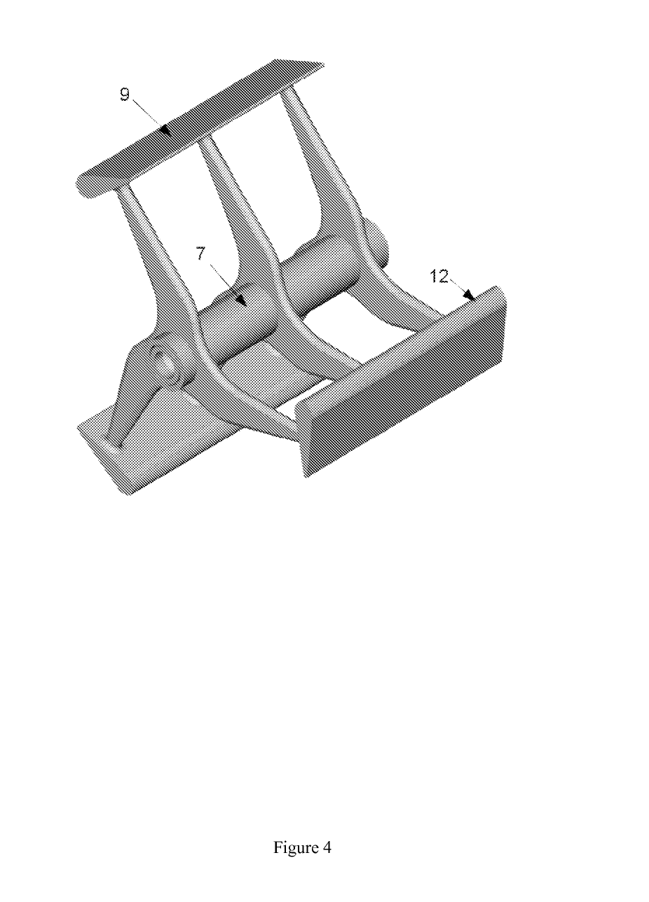

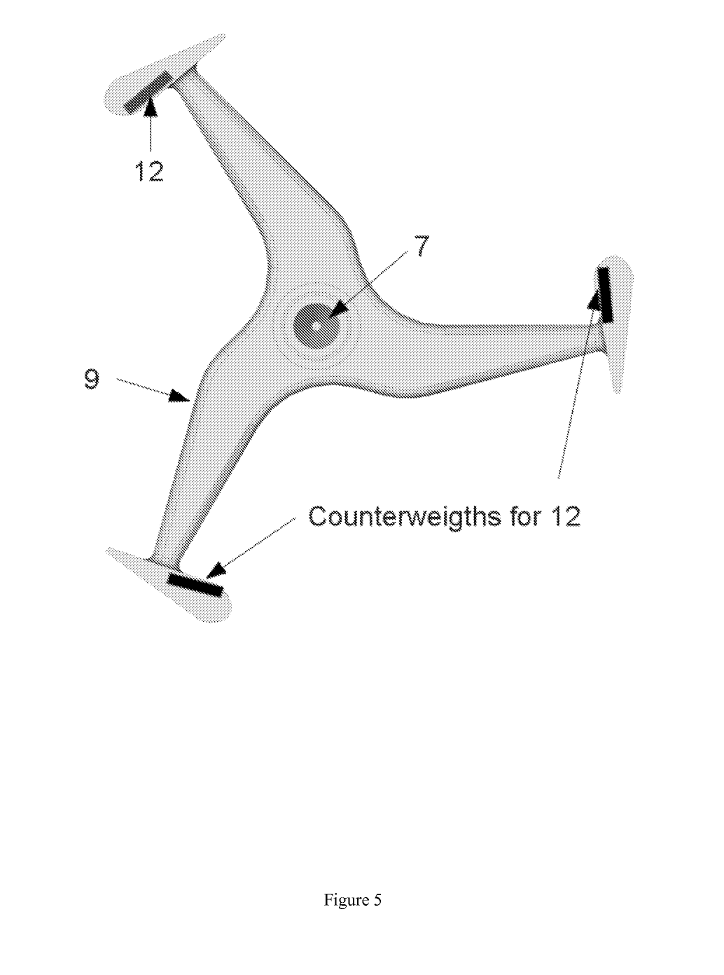

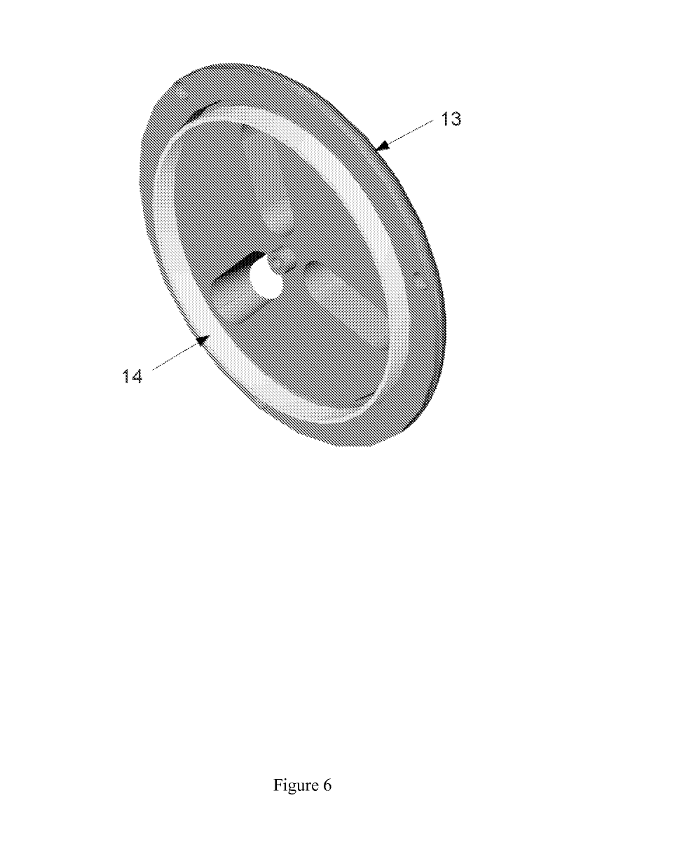

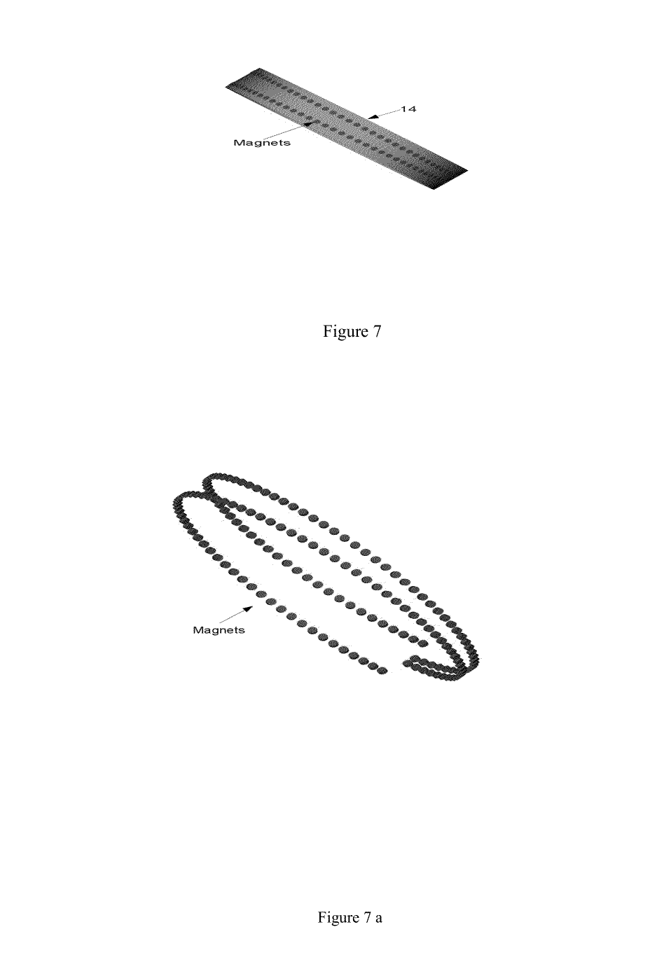

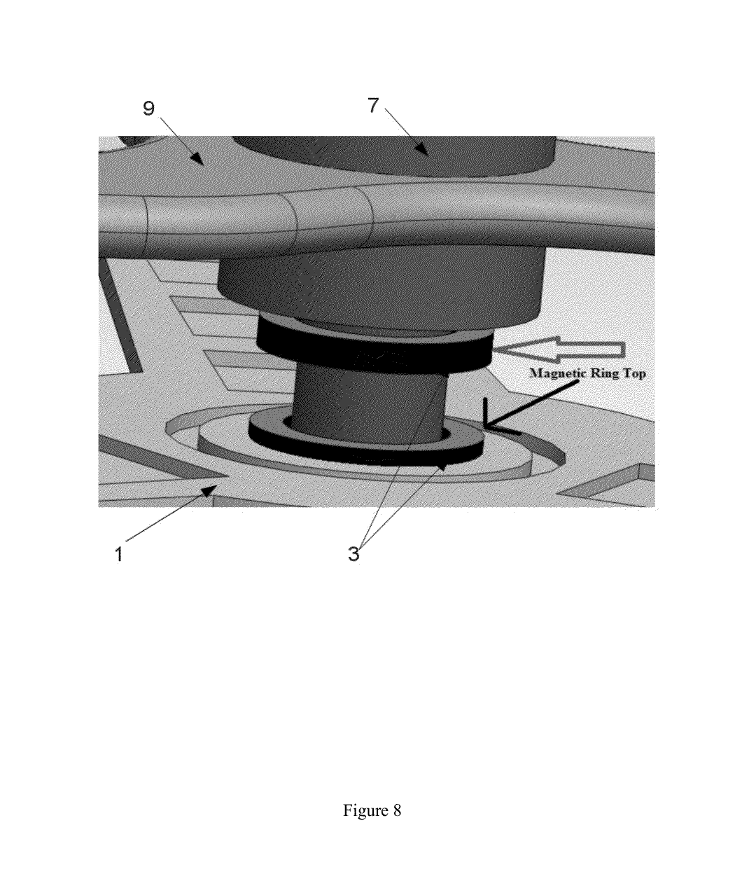

The main components are the supporting frame shown in FIG. 3, the rotor with the tangential push magnet and main shaft as shown in FIGS. 4 and 5, the top cover with the magnet ring shown in FIGS. 6, 7 and 7a, as well as the levitation magnets in FIG. 8.

Horizontal wind forces act on the main vertical airfoils of the rotor (FIG. 4, part 9) while vertical wind forces act upon the horizontal airfoils which also hold the main blades together.

The particular shape of the rotor is designed to capture wind forces from any direction, and the vertical component can be significant if the turbine location is optimized for capturing air flow follow the roof surface of a house with a valmet/V-shaped profile.

The main rotor contains a push magnet (FIG. 5, part 12) located in the top of one of the vertical air-foils, as well as two non-magnetic counterweights of equal mass and location as the push magnet, each placed in the other two vertical blades, so that the rotor is perfectly balanced.

The permanent push magnet interacts repulsively with the magnets located in the magnet ring holder (FIGS. 6 and 7, part 14)

The magnetic tangential force is achieved through placing small, e.g. for example 20 mm diameter, 5 mm thick, neodym permanent magnets placed in a varying geometrical pattern around the circumference of the magnetic ring holder, of which one possible embodiment is shown in FIGS. 7 (front view) and 7a (full circle, ring made transparent for the purpose of illustration).

The magnetic ring pattern (FIG. 7, part 14), the push magnet (FIG. 5, part 12) and the main shaft (part 7, Table 1) with its mass and optional cone-shaped centered magnets (parts 4 and 7, Table 1) are balanced in such a way to avoid any magnetic dead-lock of the rotor.

The placement of counteracting ring magnets in the main shaft (FIG. 8, part 7) and the bottom plate (FIG. 8, Part 1), as well as the conical top key and shaft magnets (Table 1, parts 4 and 7) cancels out the summed weight of the rotor and shaft, allowing a heavy shaft which preserve angular momentum. This in turn helps the rotor spinning past the potential deadlock point of the magnetic ring (FIG. 7, part 14).

The top cover (FIG. 1, part 13) is not merely a protection against rain and icing conditions in cold climates, but also houses the three-phase generator as well as holds and protects the magnetic ring that converts magnetic repulsion to rotational force.

The top cover illustrated (FIG. 1, part 13) is one suggested embodiment, but there are other alternatives as this part is subject to optimization with respect to vertical airflow for the size and generator type chosen. The top cover vents are made bigger from below to ease upward air flow and reduce downward water flow in case of rain and risk for icing. The number, shape and placement of the top cover vents will depend upon whether icing protection is needed or not.

The physical dimensions of the MagnoWind VAWT is scalable according to power output needs, but the design optimization criterion is to minimize physical size while still delivering minimum 2.5 kW output through the use of magnetic spin.

The patent claim is the unique combination of three principle components (A multiple dependent claim):

1. A set of permanent magnet rings (part 3) are used to counteract the weight of added mass in the rotating shaft to optimize spinning momentum, i.e. to keep the turbine spinning longer when wind force is reduced.
a. The specific magnetic pattern in the magnet ring together with the rotor push magnet generates a tangential force on the turbine rotor that optimize turbine output.
b. The spinning momentum reduces the impact of magnetic deadlock in the in the “v”-shaped magnet pattern in the magnet ring (part 14).
c. The conic permanent magnets are used to compensate for added mass to maximize torque for a rotating body spinning in a friction-free auto-centering bearing that stabilizes the turbine rotor to avoid wobble.

2. The main wing holders are themselves air-foils capturing vertical directed wind, in addition to the primary horizontal wind captured by the main blades.
a. Vertical and horizontal air foils blades (wing holders) together capture wind from any angle.
b. Solid design concept, all the blades (3 horizontal and 3 vertical) are made in one part, this is combined with an airfoil design of a wing system, making use of all wind passing through the turbines volume, rather than just the main plane or area in traditional wind turbines.

3. The main thrust of this patent lies in using the magnetic technology in an efficient way. Rather than using traditional bearing technology, magnetic technology is efficient in supporting and centering the rotating shaft as well as increase the force making the turbine rotate.
